(19) United States
(12) Patent Application Publication
(10) Pub. No.: US 2014/0180836 A1
(43) Pub. Date: Jun. 26, 2014

(54) CONTEXTUAL CONTENT TARGETING

(71) Applicant: YAHOO! INC., Sunnyvale, CA (US)

(72) Inventors: Sarah Sosiak, San Francisco, CA (US); Roger William Graves, San Francisco, CA (US); Michael John Kerns, JR., San Francisco, CA (US); Steven McClelland, San Francisco, CA (US)

(73) Assignee: YAHOO! INC., Sunnyvale, CA (US)

(21) Appl. No.: 13/724,793

(22) Filed: Dec. 21, 2012

(51) Int. Cl. G06Q 30/02

(52) U.S. Cl. CPC G06Q 30/0277
USPC 705/14.73

(57) ABSTRACT

Techniques are provided, relating to online advertising, in which a special link, which may be a short link, associated with an advertiser, may be provided to a user on a first Web page, such as on a social networking related Web site. The special link may be part of an advertisement or communication from the advertiser. If the user clicks on or otherwise activates the special link, a branded version of a second Web page, including particular content, may be presented to the user, which includes a particular advertisement of the advertiser. Users who arrive at the second Web page via links other than special links will be presented with a non-branded version of the Web page, which does not include the particular advertisement of the advertiser. The particular content may be pre-selected by the advertiser, such as part of a content set associated with an advertising campaign.

### BACKGROUND

Through various forms of advertising and advertising arrangements, such as keyword-based sponsored search advertising, advertisements, including targeted advertisements, may be selected and served to users. For example, content bundles and advertisements may be selected based in part on a keyword included in a user query, or based at least in part on a keyword appearing in a Web page or article. Additionally, for social networking and other social Web sites, advertisers may be able to present advertisements to users, such as users that may “like” or follow a particular brand, for example. None the less, advertisers have been limited in various ways in terms of advertising arrangements and capabilities, including in connection with specific contexts or specified content.

### SUMMARY

Some embodiments of the invention provide techniques, relating to online advertising, in which a special link, which may be a short link, associated with an advertiser, may be provided to a user on a first Web page, such as on a social networking related Web site. The special link may be part of or associated with an advertisement or communication from the advertiser. If the user clicks on or otherwise activates the special link, a branded version of a second Web page, including particular content, may be presented to the user, which includes a particular advertisement of the advertiser. Users who arrive at the second Web page via links other than special links will be presented with a non-branded version of the Web page, which does not include the particular advertisement of the advertiser. The particular content may be pre-selected by the advertiser, such as part of a content set associated with an advertising campaign.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

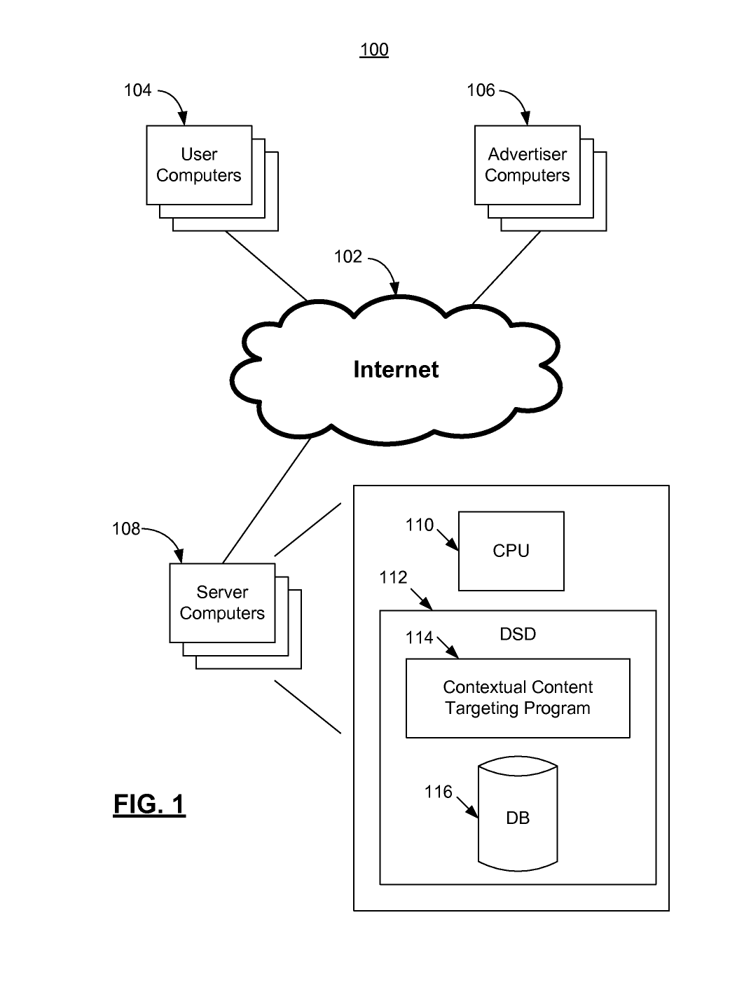

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and Contextual Content Targeting Program 114.

The Program 114 is intended to broadly include all programming, applications, algorithms, software, engines, modules, functions, and other tools necessary to implement or facilitate methods and systems according to embodiments of the invention. The elements of the Program 114 may exist on a single server computer or be distributed among multiple computers or devices.

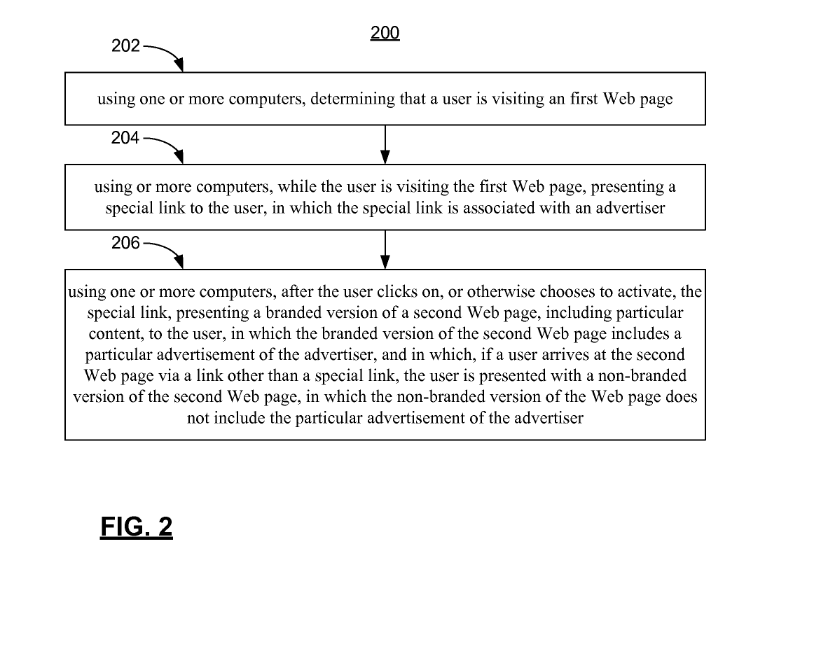

FIG. 2 is a flow diagram illustrating a method 200 according to one embodiment of the invention. Step 202 includes, using one or more computers, determining that a user is visiting a first Web page.

Step 204 includes, using or more computers, while the user is visiting the first Web page, presenting a special link to the user, in which the special link is associated with an advertiser.

Step 206 includes, using one or more computers, after the user clicks on, or otherwise chooses to activate, the special link, presenting a branded version of a second Web page, including particular content, to the user. The branded version of the second Web page includes a particular advertisement of the advertiser. If a user arrives at the second Web page via a link other than a special link, the user is presented with a non-branded version of the second Web page, in which the non-branded version of the Web page does not include the particular advertisement of the advertiser.

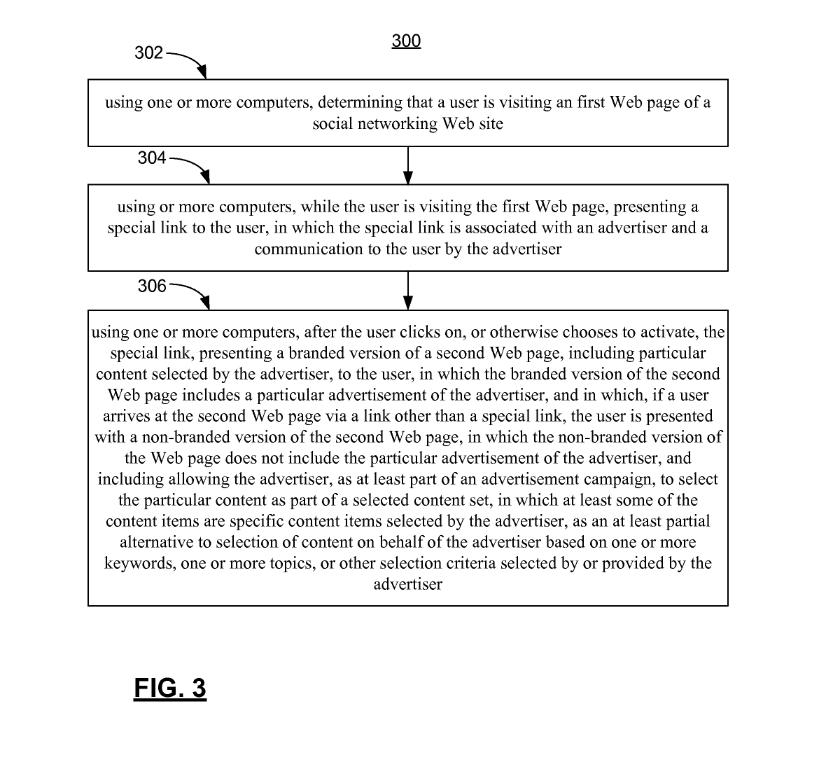

FIG. 3 is a flow diagram illustrating a method 300 according to one embodiment of the invention. Step 302 includes, using one or more computers, determining that a user is visiting a first Web page of a social networking Web site.

Step 304 includes, using or more computers, while the user is visiting the first Web page, presenting a special link to the user, in which the special link is associated with an advertiser and a communication to the user by the advertiser.

Step 306 includes, using one or more computers, after the user clicks on, or otherwise chooses to activate, the special link, presenting a branded version of a second Web page including content selected by the advertiser, including particular content selected by the advertiser to the user. The branded version of the second Web page includes a particular advertisement of the advertiser. If a user arrives at the second Web page via a link other than a special link, the user is presented with a non-branded version of the second Web page. The non-branded version of the Web page does not include the particular advertisement of the advertiser. The advertiser is allowed, as at least part of an advertisement campaign, to select the particular content as part of a selected content set, in which at least some of the content items are specific content items selected by the advertiser, as an at least partial alternative to selection of content on behalf of the advertiser based on one or more keywords, one or more topics, or other selection criteria selected by or provided by the advertiser. In some embodiments, Web pages can be the content selected by an advertiser. As such, in some embodiments, the advertiser may select certain Web pages containing particular content, and not, for example, select content to be part of a Web page.

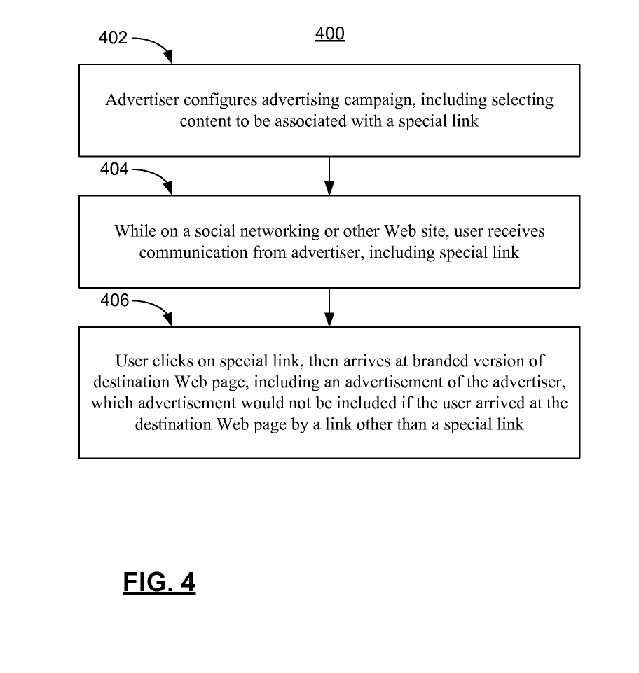

FIG. 4 is a flow diagram illustrating a method 400 according to one embodiment of the invention. At step 402, an advertiser configures an advertising campaign, including selecting content to be associated with a special link.

At step 404, while on a social networking or other Web site, a user receives a communication from the advertiser, including special link.

At step 406, the user clicks on special link, and arrives at branded version of the destination Web page, including an advertisement of the advertiser, which advertisement would not be included if the user arrived at the destination Web page by a link other than a special link.

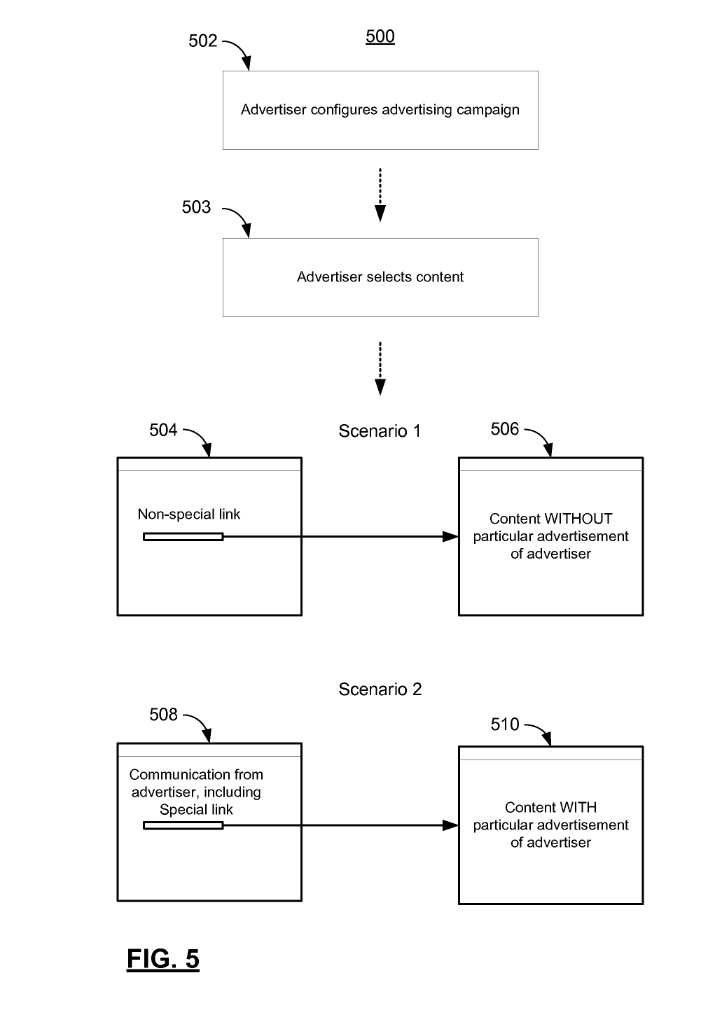

FIG. 5 is a block diagram 500 illustrating one embodiment of the invention.

Block 502 represents an advertiser configuring an advertising campaign

Block 503 represents the advertising selecting content, which can include near-real time or real time selection of content or Web pages, and can also include taking out certain selections or adding selections. In some embodiments, The advertiser selects the particular content, such that, when a user arrives at a Web page including the selected particular content, the Web page includes a particular advertisement of the advertiser. Conversely, for a user that arrives at the Web page via a link other than a special link, the Web page does not include the particular advertisement of the advertiser.

To illustrate, in Scenario 1, as depicted, a user on a Web page 504 clicks on a non-special link. The user arrives at the destination Web page 506 not including the particular advertisement of the advertiser.

Conversely, in scenario 2, as depicted, a user on a Web page 508 clicks on a special link, and arrives at the destination Web page 510 including the particular advertisement of the advertiser. Furthermore, as depicted, the special link may be included in a communication from the advertiser to the user.

In various forms of advertising, such as keyword-based or topical advertising, advertisements of advertisers are served to users in connection with content. Of course, the advertisements may also be targeted to users in various ways.

In some embodiments of the invention, advertisers select particular items of content, such as an article, for instance. It is arranged that, in certain instances, a special link is provided to user, which special link will lead the user to version of a Web page containing the selected content, and also containing a particular advertisement. The particular advertisement may be selected or determined by the advertiser in connection with the special link scenario. The version of the Web page with the particular advertisement may be called a branded version of the Web page.

If a user arrives at the Web page via any non-special link, then the user may be presented with a version of the Web page that does not include the particular advertisement. This may be called a non-branded version of the Web page.

In some embodiments, an advertiser may communicate or advertise to a user, or a particular, targeted user, and the communication or advertisement may include a special link, thus providing what may be thought of as a contextual link. For example, suppose that a user is a follower of, or “likes” a particular brand on a social networking site, such as Twitter, Facebook, etc. An advertiser associated with the brand may send a message, or tweet, etc., to the user, which may include a special link. Because of the arrangements made by the advertiser prior to this, the advertiser may know that, if the user clicks on the special link, the user will arrive at a branded version of the Web page, whereas users arriving at the Web page via non-special links, such as various links not associated with the advertiser or the brand of the advertiser, will arrive at a non-branded version of the Web page.

For example, the communication to the user may be associated with an article that the user may be interested in, which may the particular content selected by the advertiser. For example, it might be an article on cars, and the brand may be Toyota. If the user clicks on the special link, the user arrives at a branded version of the destination Web page, which may be a Web page including the car article as well as an advertisement for Toyota cars, which advertisement may or may not be topically associated with the article.

In some embodiments, the advertiser makes arrangements (such as with one or more advertising campaign facilitating entities, which may have relationships with multiple advertisers, publishers, etc.) such that the branded version of the Web page includes only the particular advertisement of the advertiser, and the non-branded version of the Web page includes no advertisements at all, or limited advertisements, only advertisements of a certain type, etc. Of course, such an arrangement may be more expensive, etc.

In some embodiments, special links may be forwarded from a user to one or more other users, such as by being shared via social networking sites, etc. Although various embodiments are contemplated, in some embodiments, in such instances, special links that are shared or forwarded, or re-shared or re-forwarded any number of times, maintain their specialness. If a shared or forwarded, or re-shared or re-forwarded link, retains its specialness, then a user clicking on such a link would arrive at a branded version of the Web page, just as would the user who received the original special link. In this way, special links, and branded Web pages, can potentially “go viral”, benefiting the advertiser and the brand of the advertiser.

Various embodiments of the invention contemplate various forms of special links. For example, in some embodiments, special links may be shortened or short links. For example, some companies, such as Bitly, assist customers with short links. Various other forms of special links are contemplated, such as special links that use data incorporated within or at the end of a parameter in a URL, methods that include utilization of referred data, etc.

In some embodiments, possibly as part of configuring or setting up an online advertising campaign, such as through an entity or Web portal that provides such services, an advertiser may, through a provided graphical user interface or other interface, configure or define a special link, as well as a particular content item associated with the special link, and a particular associated advertisement.

After such configuration, the advertiser may share the special link with users, such as though online communications, advertisements, social networking messages, etc.

Furthermore, in some embodiments, an advertiser can configure content sets including multiple content items, some or all of which can be associated with special links. Still further, in some embodiments, such sets may be configurable or may be modified in real time. As such, as an advertiser finds new, appropriate content on the Web, the advertiser is able to modify the content set to include such content. For example, this may allow an advertiser, in real time, to identify a trending or increasingly popular or relevant article, etc., and select it as part of a set, which ability may not be provided in, for example, keyword-based or topical advertising.

In some forms of advertising, such as keyword-based or topical advertising, an advertiser has some control of the content with which the advertiser's advertisement will be associated, but the advertiser does not choose the specific content. Rather, in these forms of advertising, content items are selected or curated for the advertiser, although often based on advertiser-supplied or selected criteria. Some embodiments of the invention allow advertisers, among other things, to choose particular, specified content to be associated with the advertiser's advertisements, in a branded fashion.

Furthermore, in some embodiments, performance data and analytics may be collected and provided to the advertiser, to allow tracking and evaluation of advertisement performance in connection with special links and associated advertisements on branded Web pages.

While the invention is described with reference to the above drawings, the drawings are intended to be illustrative, and the invention contemplates other embodiments within the spirit of the invention.

1. A method comprising:
using one or more computers, determining that a user is visiting a first Web page;
using or more computers, while the user is visiting the first Web page, presenting a special link to the user, wherein the special link is associated with an advertiser; and
using one or more computers, after the user clicks on, or otherwise chooses to activate, the special link, presenting a branded version of a second Web page, comprising particular content, to the user, wherein the branded version of the second Web page includes a particular advertisement of the advertiser, and wherein, if a user arrives at the second Web page via a link other than the special link, the arriving user is presented with a non-branded version of the second Web page, wherein the non-branded version of the Web page does not include the particular advertisement of the advertiser.

2. The method of claim 1, comprising presenting the special link to the user, wherein the special link is a short link.

3. The method of claim 1, comprising presenting the special link to the user, wherein a special link is one that is provided to the user by or for the advertiser, and wherein a link other than a special link is one that is not provided by or for the advertiser.

4. The method of claim 1, comprising allowing the advertiser to select the particular content.

5. The method of claim 1, comprising allowing the advertiser to select the particular content as part of a selected advertising content set, in which at least some of the content items are specific content items selected by the advertiser.

6. The method of claim 1, comprising allowing the advertiser to select the particular content as part of a selected advertising content set, in which at least some of the content items are specific content items selected by the advertiser, as an at least partial alternative to relying on selection of content on behalf of, as opposed to by, the advertiser based on one or more keywords, one or more topics, or other selection criteria selected by the advertiser.

7. The method of claim 1, comprising allowing the advertiser to select the particular content as part of a selected advertising content set, and comprising allowing the advertiser to modify the set over time as new or different content becomes available for selection.

8. The method of claim 1, comprising allowing the advertiser to select the particular content, and wherein the particular content comprises an article.

9. The method of claim 1, wherein the special link is provided to the user as part of an advertisement.

10. The method of claim 1, wherein the special link is provided to the user as part of an online coupon or an offer.

11. The method of claim 1, wherein the special link is provided to the user as part of a tweet.

12. The method of claim 1, wherein the special link is provided to the user as part of, or associated with, a chat or dialog.

13. The method of claim 1, wherein the first Web page is of a social networking Web site.

14. The method of claim 1, wherein the first Web page is of a social networking Web site, and wherein, in connection with the Web site, the user is a follower of, or has elected to like, the advertiser or a brand associated with the advertiser.

15. A system comprising:
one or more server computers coupled to a network; and
one or more databases coupled to the one or more server computers;
wherein the one or more server computers are for:
determining that a user is visiting a first Web page;
while the user is visiting the first Web page, presenting a special link to the user, wherein the special link is associated with an advertiser; and
after the user clicks on, or otherwise chooses to activate, the special link, presenting a branded version of a second Web page, comprising particular content, to the user, wherein the branded version of the second Web page includes a particular advertisement of the advertiser, and wherein, if a user arrives at the second Web page via a link other than the special link, the arriving user is presented with a non-branded version of the second Web page, wherein the non-branded version of the Web page does not include the particular advertisement of the advertiser.

16. The system of claim 15, wherein at least one of the one or more server computers are coupled to the Internet.

17. The system of claim 15, comprising presenting the special link to the user, wherein the special link is a short link.

18. The system of claim 15, comprising presenting the special link to the user, wherein a special link is one that is provided to the user by or for the advertiser, and wherein a link other than a special link is one that is not provided by or for the advertiser.

19. The system of claim 15, comprising allowing the advertiser to select the particular content.

20. A computer readable medium or media containing instructions for executing a method comprising:
using one or more computers, determining that a user is visiting a first Web page of a social networking Web site;
using or more computers, while the user is visiting the first Web page, presenting a special link to the user, wherein the special link is associated with an advertiser and a communication to the user by the advertiser; and
using one or more computers, after the user clicks on, or otherwise chooses to activate, the special link, presenting a branded version of a second Web page, comprising particular content selected by the advertiser, to the user, wherein the branded version of the second Web page includes a particular advertisement of the advertiser, and wherein, if a user arrives at the second Web page via a link other than the special link, the arriving user is presented with a non-branded version of the second Web page, wherein the non-branded version of the Web page does not include the particular advertisement of the advertiser, and comprising allowing the advertiser, as at least part of an advertisement campaign, to select the particular content as part of a selected content set, in which at least some of the content items are specific content items selected by the advertiser, as an at least partial alternative to selection of content on behalf of the advertiser based on one or more keywords, one or more topics, or other selection criteria selected by or provided by the advertiser.
